(19) United States
(12) Patent Application Publication
(10) Pub. No.: US 2025/0039501 A1
(43) Pub. Date: Jan. 30, 2025

(54) STREAMING WITH RESOLUTION ESCALATION FOR REDUCED LATENCY IN MEDIA CONTENT STREAMING APPLICATIONS

(71) Applicant: Google LLC, Mountain View, CA (US)

(72) Inventor: Dongeek Shin, San Jose, CA (US)

(21) Appl. No.: 18/360,233

(22) Filed: Jul. 27, 2023

(51) Int. Cl. H04N 21/4402; G06T 3/40

(52) U.S. Cl. CPC H04N 21/440263; G06T 3/4046; G06T 3/4053

(57) ABSTRACT

Techniques and systems are disclosed that reduce latency in streaming media items. The techniques include communicating, to a media streaming service, a selection of a media item from a client device, receiving, from the media streaming service, a first portion of the media item having a first resolution and presenting, using the first portion, the media item on a presentation interface of the client device. The techniques further include receiving, from the media streaming service, a second portion of the media item having a second resolution, and presenting, responsive to an occurrence of a first threshold condition, the second portion of the media item on the presentation interface of the client device.

### TECHNICAL FIELD

Implementations of the present disclosure relate to computing systems, and more specifically, to methods and systems that integrate artificial intelligence functionality with other computer technologies.

### BACKGROUND

Media streaming services, which may include video-hosting services, social-networking media, online search engines, and so on, provide media content to users over the Internet. Typically, a user accesses a media streaming service by requesting (e.g., clicking on) a specific media content (e.g., a video or audio) of interest to the user or by accessing a website of the streaming service. The requested content then begins downloading to the user's computer from a suitable streaming server. To prevent delays during presentation of the content to the user, a portion of the content can be downloaded prior to the beginning of the presentation. As the user is viewing (and/or listening to) the content, the media streaming service can offer additional suggestions to the user about media content that may be of interest to the user. Such suggestions can be based on the currently viewed content as well as on the content accessed during previous user sessions with the streaming service. The user can then access multiple content items, with some items watched (and/or listened to) fully and other items watched partially.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

The subject matter of the disclosure relates to presentation of a series of versions of a media item with escalated resolution, when network bandwidth is not sufficient to stream a maximum resolution version without latency. According to one aspect of the present disclosure there is provided a method that includes communicating, to a media streaming service, a selection of a media item from a client device. The method further includes receiving, from the media streaming service, a first portion of the media item, the first portion having a first resolution. The method further includes presenting, using the first portion, the media item on a presentation interface of the client device. The method further includes receiving, from the media streaming service, a second portion of the media item, the second portion having a second resolution. The method further includes presenting, responsive to an occurrence of a first threshold condition, the second portion of the media item on the presentation interface of the client device.

According to another aspect of the present disclosure there is provided a system that includes one or more devices, the one or more devices configured to carry out the method described herein. The system may include a memory device and a processing device communicatively coupled to the memory device, the processing device performing various actions of “receiving,” “generating,” “providing,” and “updating.”

According to another aspect of the present disclosure there is provided a non-transitory computer-readable medium to store instructions, which when executed by a processing device, cause the processing device to carry out the method described herein above . . .

### BRIEF DESCRIPTION OF THE DRAWINGS

The disclosure is illustrated by way of example, and not by way of limitation, and can be more fully understood with references to the following detailed description when considered in connection with the figures, in which:

FIG. 1 illustrates an example architecture of a system capable of reducing latency in streaming of media items using one or more compressed versions of the items being streamed, in accordance with one or more aspects of the present disclosure.

FIG. 2 illustrates an example workflow of latency reduction in live streaming of media using one or more reduced-resolution versions of the media items being streamed, in accordance with one or more implementations of the present disclosure.

FIG. 3 illustrates latency reduction in live streaming of media using one compressed version of a requested media item, in accordance with one or more implementations of the present disclosure.

FIG. 4 is a flow diagram of an example method of latency reduction in live streaming of media using one or more reduced-resolution versions of the media items being streamed, in accordance with one or more implementations of the present disclosure.

FIG. 5 depicts an example computer system that can perform any one or more of the methods described herein, in accordance with some implementations of the present disclosure.

### DETAILED DESCRIPTION

Media viewing (understood as including watching and/or listening herein) can be negatively affected by delays in downloading requested media content. Such delays can include the delays between the time a user selects a content item and the beginning of viewing of the selected content and delays that can occur later, once the viewing has commenced. The user experiencing such delays is much more likely to navigate away from the media service and/or remember negative experience. This is especially important for high-resolution, immersive videos where network bandwidth is most taxed while a noticeable latency can ruin the whole viewing experience. Because users can connect to media viewing services via network connections of varying bandwidths and throughputs, finding universal solutions that work under all conditions is difficult.

Aspects and implementations of the instant disclosure address the above-mentioned and other challenges of the existing media delivery technology by providing for systems and techniques capable of leveraging resources of user's computers to overcome network limitations and maximize user's enjoyment of media streaming. More specifically, when a user requests an access to a media item, a compressed (reduced-resolution) version of at least a portion of the media item may be quickly provided to the user's device. The reduced-resolution version may be displayed to the user while a higher-resolution version is being downloaded concurrently in the background. Once a sufficient part of the higher-resolution version is downloaded, the reduced-resolution version may cease to be displayed (or otherwise provided) to the user, being replaced with the higher-resolution version. A resource evaluation engine may evaluate a current state (bandwidth, throughput, etc.) of the network connection and, in some instances, processing resources of the user's device to determine what portion of the media item should be displayed using reduced resolution while allowing the rest of the media item to be downloaded in the higher-resolution version to ensure uninterrupted viewing experience.

In some implementations, the reduced-resolution version of the media item may be processed by an upsampling (super resolution) module that enhances resolution of the media item. The upsampling module may deploy one or more machine learning models (e.g., deep learning neural networks) that use the reduced-resolution version of the media item (e.g., 480×360 pixel video), as an input, and generates an output media item in a higher resolution (e.g., 1920×1,080 pixel video). The machine learning model may have one or more convolutional neuron layers that are capable of capturing a broader context of a media item frame (or a set of frames) than what would have been captured by a purely local (e.g., spline-based) upsampling. As a result, the upsampling model outputs an upsampled modification of the compressed version that has a significantly higher perceived resolution than the reduced-resolution version itself. In some implementations, multiple reduced-resolution versions of the media item may be downloaded, each having a different resolution that is less than the maximum-resolution version (referred to as the native resolution herein). Correspondingly, multiple (e.g., M) upsampling models may be available on the user's device, each model trained to accept media item inputs of respective resolutions. Each additional upsampling model may have less sophisticated architecture (e.g., a number of neuron layers) since upsampling of inputs with progressively increased resolution may require fewer computations. A special media presentation scheduler may evaluate available computing and network resources and generate an optimal schedule for presentation of the compressed (and upsampled) versions of the media item. For example, the media presentation scheduler may determine that frames [1, N₁] of the media item should be downloaded in the lowest resolution (version 1), frames [N₂′, N₂] downloaded in the next lowest resolution (version 2), and so on, with that frames [N_{M}′, N_{M}] downloaded in the last, Mth, reduced resolution, and that starting with frame N_{NAT}, the ultimate native resolution version will be presented. The frame intervals assigned to each version may be overlapping, e.g., with N₂′>N₁, . . . , N′_{M}>N_{M-1}, and N_{NAT}>N_{M}, to accommodate for unexpected deterioration of the network transmission. Numerous other implementations and variations of these techniques are disclosed herein.

The advantages of the disclosed techniques include but are not limited to improving media viewing experience by preventing or minimizing waiting time via the use of one or more compressed versions that can be downloaded quickly and presented to the user with or without upsampling. This serves as a stop-gap process during downloading of the native resolution media item(s) and reduces significantly or eliminates completely the time when the user is presented with an empty or frozen screen. This, in turn, increases user's satisfaction and improves the overall experience of the user interacting with media streaming services.

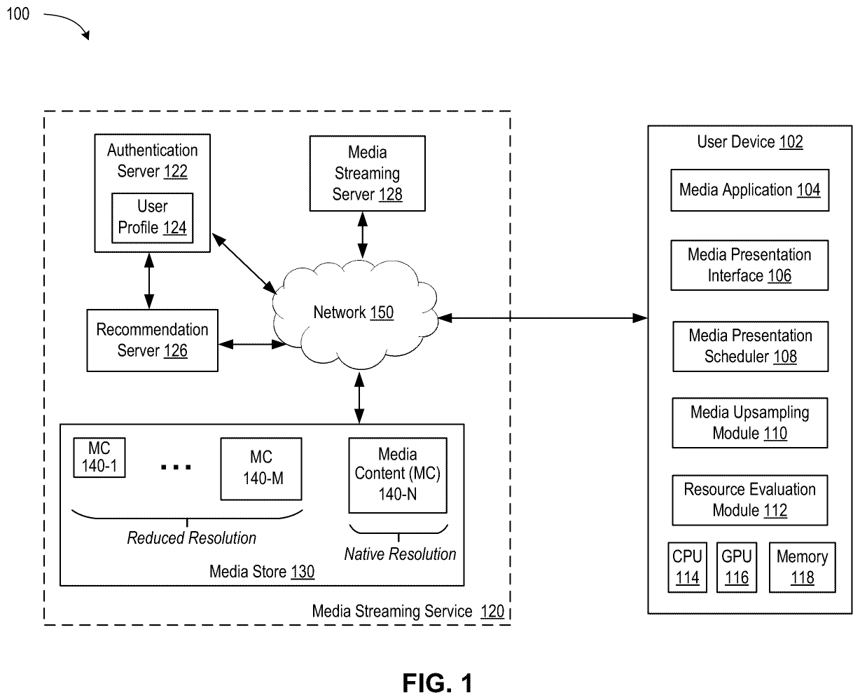

FIG. 1 illustrates an example architecture of a system 100 capable of reducing latency in streaming of media items using one or more compressed versions of the items being streamed, in accordance with one or more aspects of the present disclosure. The system 100 may include a user device 102 and a media streaming service 120 providing media content to users (clients). Although a single user device 102 is illustrated in FIG. 1, media streaming service 110 may support any number of user devices (machines, computers, etc.), each user device supporting any number of users, e.g., connecting to media streaming service 110 via respective user sessions. Each user device 102 (also referred to as a client device herein) may include one or more computing devices such as personal computers (PCs), laptops, mobile phones, smart phones, tablet computers, netbook computers, network-connected televisions, augmented/mixed/virtual reality devices, and/or the like. User device 102 may include a media application 104 that allows one or more users of user device 102 to download, view, and/or upload media content, such as images, video items, audio items, web pages, documents, and/or the like. For example, media application 104 may use a web browser that can access, retrieve, present, and/or navigate content (e.g., web pages such as Hyper Text Markup Language (HTML) pages, digital media items, etc.) served by media streaming service 120.

In some implementations, media application 104 may be a standalone application (e.g., a mobile application) that allows users to view digital media items, e.g., digital video items, digital audio items, digital images, electronic books, etc. According to aspects of the disclosure, media application viewer 104 may be a content sharing platform application allowing users to record, edit, and/or upload content for sharing on the content sharing platform. In such implementations, media application 104 may be provided to user device(s) 102 by the content sharing platform supported by media streaming service 120.

Media application 104 may render, display, and/or present the content (e.g., a web page, a media viewer) to a one or more users using a media presentation interface 106, which may include a combination of hardware components (e.g., any suitable display, monitor, touchscreen, speakers, augmented/mixed/virtual reality headsets, and/or a combination thereof) and software programs (e.g., drivers, application programming interfaces, graphical user interfaces, browsers, smartphone/tablet applications, and or the like). Media presentation interface 106 may also include an embedded media player (e.g., a Flash® player or an HTML5 player) that is embedded in a web page. In one example, media presentation interface(s) 106 may be applications that are downloaded from one or servers of media streaming service 120.

In one implementation, media streaming service 120 may include one or more computing devices, such as rackmount servers, routers, data processing servers, personal computers, mainframe computers, laptop computers, tablet computers, desktop computers, and/or various hardware and software components that may be used to provide users of user device(s) 102 with access to media items and/or provide the media items to the user. For example, media streaming service 120 may allow a user to consume, upload, search for, approve of (“like”), disapprove of (“dislike”), or comment on media items.

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user.” Users may access media items. Examples of media items include, but are not limited to, digital video, digital movies, digital photos, digital music, audio content, melodies, website content, social media updates, electronic books (ebooks), electronic magazines, digital newspapers, digital audio books, electronic journals, web blogs, real simple syndication (RSS) feeds, electronic comic books, software applications, and/or the like. Throughout this disclosure, media items may also be referred to as content or content items.

A media item may be consumed via the Internet or via a mobile device application. For brevity and simplicity, a video item may be used as an example of a media item throughout this disclosure. As used herein, “media,” media item,” “online media item,” “digital media,” “digital media item,” “content,” and “content item” can include an electronic file that can be executed or loaded using software, firmware, or hardware configured to present the digital media item to an entity. In one implementation, media streaming service 120 may store media content in media store 130, e.g., as electronic files in one or more formats.

In one implementation, the media content includes video content (video items or videos). A video item may include a set of sequential video frames (e.g., image frames) representing a scene in motion. For example, a series of sequential video frames may be captured continuously or later reconstructed to produce animation. Video items may be presented in various formats including, but not limited to, analog, digital, two-dimensional videos, three-dimensional videos, and/or the like. Video items may include movies, video clips or any set of animated images to be displayed in sequence. In addition, a video item may be stored as a video file that includes a video component and an audio component. The video component may refer to video data in any suitable video coding format or image coding format (e.g., H.264, H.265, VP9, AV1, and/or the like). The audio component may refer to audio data in an audio coding format (e.g., advanced audio coding (AAC), MP3, and/or the like.)

In some implementations, users of media streaming service 120 may be able to create, share, view, and/or use playlists containing multiple media items. A playlist refers to a collection of media items that are configured to play one after another in a particular order without user prompts. In some implementations, media streaming service 120 may maintain such playlists on behalf of users. In some implementations, media streaming service 120 may place a media item on a playlist to user device 102 for playback or display. For example, media presentation interface 106 may be used to play media items from the playlist in the order in which the media items are listed on the playlist. In another example, a user may transition between media items on a playlist. In yet another example, a user may wait for the next media item on the playlist to play or may select a particular media item in the playlist for playback.

In one example implementation, media streaming service 120 may include an authentication server 122 that authenticates access of a user of user device 102 to media streaming service 120 over a network 150. Authentication may include verification of the user's credentials and rights to access content of media streaming service 120, including playlists previously created by the user (or created for the user by media streaming service 120). Authentication may be performed using any known techniques including password authentication, two-step authentication, biometric authentication, and/or the like. Authentication may be performed in conjunction with encryption, e.g., encryption of two-way data communications between user device 102 and media streaming service 120. Authentication may include accessing a user profile 124, which may store various user-specific preferences defined by the user or suggested by media streaming service 120 during the current user session and/or one or more previous user sessions.

After a new user session has been authenticated by authentication server 122, a recommendation server 126 may recommend one or more media items to the user, e.g., based on user preferences and/or other data stored in user profile 124, which may include media items from one or more playlists associated with user profile 124 or one or more additional items that recommendation server 126 determines may be of interest to the user (e.g., one or more recently created and/or released items). The recommendation may be provided to the user and the user may select one or more items for viewing (e.g., based on the recommendation or for other reasons) and request access to the selected items. Authentication server 122 may confirm that the user has access rights to view the requested content and direct a media streaming server 128 to provide the requested content (items) to the user. Media streaming server 128 may identify a location in media store 130 where the requested media content is stored. In some implementations, the requested media content (MC) may be available in multiple resolutions, e.g., in M reduced-resolution versions of MC, e.g., MC 140-1 (lowest resolution), . . . MC 140-M, and a native (highest resolution) format MC 140-N. Media streaming server 128 may communicate to media application 104 information about various individual versions MC 140-j, such as video and/or audio resolutions, size, encoding, and/or the like.

Media presentation scheduler 108 may identify which of the available reduced-resolution versions MC 140-1 . . . . MC 140-M are to be displayed to the user and for how long. In making these determinations, media presentation scheduler 108 may use information received from a resource evaluation module 112 about available processing and network resources. More specifically, information provided by resource evaluation module 112 may include an average and peak utilization of one or more central processing units (CPUs) 114, graphics processing units (GPUs) 116, and/or various other processing units of user device 102, including but not limited to one or more data processing units (DPUs), parallel processing units (PPUs), application-specific integrated circuits (ASICs), field-programmable gate arrays (FPGA), and/or any combination thereof. Additional information provided by resource evaluation module 112 may include current and maximum utilization of memory 118 of user device 102 and various network metrics of network 150, including available bandwidth (e.g., the maximum amount of data that can be transferred, per unit of time, between media store 130 of media streaming service 120 and user device 102), throughput (e.g., the actual amount of data that can be transferred once bit errors and retransmissions are taken into account), average latency, and/or the like.

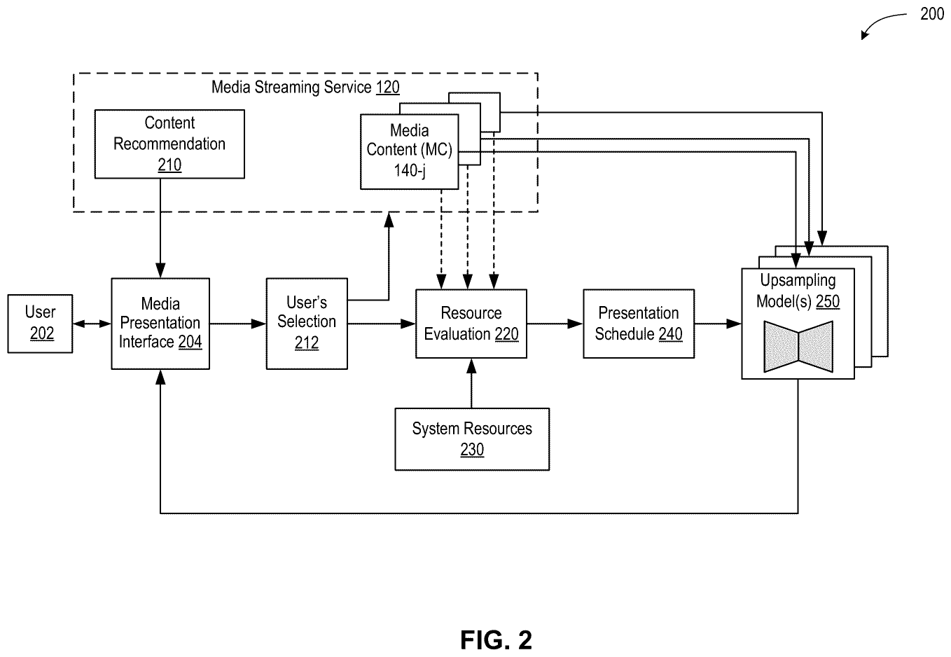

User device 102 can include a media upsampling module 110 that uses one or more upsampling techniques (including trained machine learning models) to achieve increased resolution of the media content above the nominal resolution of the media content received from media store 130 (super-resolution), as disclosed in more detail below in conjunction with FIG. 2.

In some implementations, network 150 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), and/or the like. In some implementations, network 150 may include routers, hubs, switches, server computers, and/or a combination thereof.

Media store 130 may be implemented in a persistent storage capable of storing files as well as data structures to perform identification of data, in accordance with implementations of the present disclosure. Media store 130 may be hosted by one or more storage devices, such as main memory, magnetic or optical storage disks, tapes, or hard drives, network-attached storage (NAS), storage area network (SAN), and so forth. In some implementations, media store 130 may be implemented on a network-attached file server, an object-oriented database, a relational database, and so forth.

In situations in which the systems discussed here collect personal information about users, or may make use of personal information, the users may be provided with an opportunity to control whether media streaming service 120 and/or media application 104 of user device 102 collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user May have control over how information is collected about the user and used by media streaming service 120 and/or media application 104.

FIG. 2 illustrates an example workflow 200 of latency reduction in live streaming of media using one or more reduced-resolution versions of the media items being streamed, in accordance with one or more implementations of the present disclosure. Operations of example workflow 200 may be performed by system 100 of FIG. 1. A user 202 may view various content items provided by media streaming service 120 via media presentation interface 204. In some implementations, media presentation interface 204 may display various content recommendations 210, which may be based on the user's viewing history, including playlists created by the user and/or by the cloud service for the user. User 202 may make a user's selection 212 to request one or more media items to be downloaded from media store 130. The user device (e.g., user device 102 with an instance of media application 104 operating thereon, as shown in FIG. 1) may send a request to the cloud service (e.g., to media streaming server 128) to provide a list of available versions of the requested media item(s). The cloud service may respond with a list of such versions including a number of frames (elemental units of the media items) in each version, a size of the frame in each version, a type of encoding used for each version, and/or any additional information. In some implementations, the cloud service may provide the list of versions that are available in media store 130. In some implementations, the list may further include descriptions of versions that are not currently stored in media store 130 but may be encoded by the cloud service in real time. For example, a native (maximum) resolution version and a compressed (minimum) resolution version may be stored in media store 130. Additionally, a medium resolution version may be available (upon request) from the cloud service. In one instance, the cloud service may be able to generate the medium resolution version from the native resolution version and stream the medium resolution version to user device 102.

Resource evaluation module 220 may receive the description of versions stored or otherwise available via media streaming service 120 and determine a presentation schedule 240 for presentation of the content item to the user. Resource evaluation module 220 may receive or collect performance metrics characterizing various system resources 230. The received/collected performance metrics may include current available network bandwidth of a network connection between the user device and media streaming service 120, e.g., average available network bandwidth over a certain time. The received performance metrics may also include network throughput, network latency, and/or the like. In some implementations, the received performance metrics may further include available processor (e.g., CPU/GPU/DPU/etc.) and/or memory resources of the user device, e.g., a number of processor flops and/or memory bytes available for processing of the requested media item(s) (e.g., in view of various other applications that the user device may be currently supporting).

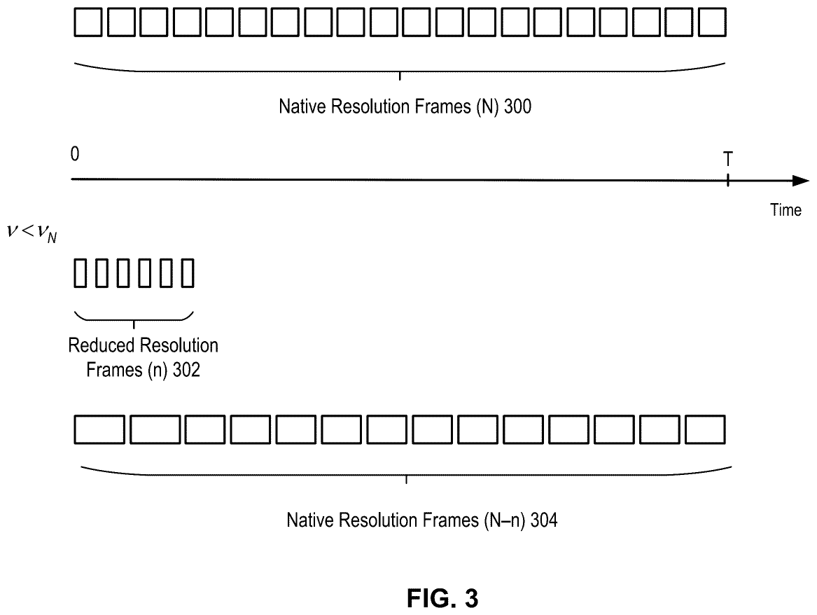

In some implementations, presentation schedule 240 may be determined to minimize latency in delivering the media item to the user while maximizing quality of presentation (e.g., resolution) of the delivered items. FIG. 3 illustrates latency reduction in live streaming of media using one compressed version of a requested media item, in accordance with one or more implementations of the present disclosure. As illustrated, a requested media item (e.g., video) may include N frames with a native resolution, e.g., ultra high definition (4K) or 3,840×2,160 pixels per frame. The media item may have duration T (e.g., in seconds). Each frame delivery may involve transmitting (on average) ƒ_{N} bits over the network. Accordingly, transmitting all Nƒ_{N} bits of the media item at native resolution without any delays may require the network bandwidth of V_{N}=Nƒ_{N}/T bits per second. It will be assumed that the current available (average) bandwidth ν is below the network bandwidth sufficient for native resolution streaming, ν<ν_{N}. Additionally, a compressed version of the same media item may be available, e.g., in the standard definition or 480×360 pixels per frame, in the full standard definition or 640×480 pixels per frame, in the high definition or 1,280×720 pixels per frame, in the full high definition or 1,920×1,080 pixels per frame, and/or the like. Each compressed frame delivery may involve transmitting ƒ₁ bits per frame. It will be assumed that the current available bandwidth ν is above the bandwidth necessary for streaming of the compressed version, ν>Nƒ₁/T.

As illustrated in FIG. 3, instead of streaming the media item at reduced resolution (which would result in lowered quality of viewing and bandwidth underutilization), or streaming the media item at native resolution (which would result in delays prior to the start of streaming or in the middle of streaming), the available network bandwidth ν may be more optimally used to stream n first frames of the (compressed) media item at reduced resolution followed with streaming of the last N−n frames of the media item at the native resolution. The following condition that the streaming is to be completed over the duration of the item T (and thus with no delays),

$$\frac{{nf}_{1} + ( N - n ) {f}_{N}}{v} = T ≡ \frac{{Nf}_{N}}{{v}_{N}} ,$$

determines the number of frames that are to be transmitted at reduced resolution,

$$n = \frac{{Nf}_{N}}{{v}_{N}} \frac{{v}_{N} - v}{{f}_{N} - {f}_{1}} .$$

When the number of data bits per frame at native resolution is significantly larger than the number of bits per frame at reduced resolution, ƒ_{N}>>ƒ₁ (e.g., the number of pixels per one frame of a 4K video is 48 times higher than per one frame of a standard definition video), this formula may be simplified to

$$\frac{n}{N} \approx 1 - \frac{v}{{v}_{N}} ,$$

meaning that the portion of frames 1−n/N transmitted with the native resolution is approximately given by the ratio of the available bandwidth to the bandwidth required for fully native streaming, ν/ν_{N}.

Correspondingly, as illustrated in FIG. 3, when ν≥ν_{N}, presentation schedule 240 may include directly streaming N native resolution frames 300 of the media item. In those instances where resource evaluation module 220 determines that ν<ν_{N}, to avoid delays in the media item streaming, presentation schedule 240 may include streaming n reduced resolution frames 302 together with N−n native resolution frames 304. (Individual frames are depicted schematically in FIG. 3 with rectangles, the horizontal extent of the rectangles indicating schematically an amount of time used to download the corresponding frames.) In some implementations, streaming of different resolution frames may be performed sequentially, e.g., with n reduced resolution frames 302 streamed first and N−n native resolution frames 304 streamed next. In some implementations, as illustrated in FIG. 3, streaming of different resolution frames may overlap, e.g., with n reduced resolution frames 302 streamed together with some of the native resolution frames 304 followed with streaming of the remaining native resolution frames 304. Even though transmission of each native resolution frame takes longer than in the ν>ν_{N} case, streaming of the last frame of the media is completed in both cases at the same time T.

When multiple reduced-resolution versions of the media item are selected for sequential presentation to the user, presentation schedule 240 may include ηᵢ frames of version i=1 . . . . M available through media streaming service 120 followed by the remaining N−Σᵢηᵢ native resolution frames. In some implementations, the number of frames ηᵢ of each resolution may be selected to satisfy the condition that the total time of presenting of all versions is equal to the correct duration T of the media item,

$${\sum }_{i = 1}^{M} {n}_{i} {f}_{i} + ( N - {\sum }_{i = 1}^{M} {n}_{i} ) {f}_{N} = {Nf}_{N} \frac{v}{{v}_{N}} .$$

The number of frames presented using each version may be set to maximize viewing satisfaction. In some implementations, to make a transition from the lowest resolution version (i=1) to the native resolution version as gradual and smooth as possible, each reduced resolution version may be presented for an equal number of frames, ηᵢ=η, which is then given by

$$n = \frac{N}{M} \frac{1 - v / {v}_{N}}{1 - f / {f}_{N}} ,$$

where ƒ=M⁻¹Σᵢ₌₁^{M}ƒᵢ, is the average number of bits per frame across the whole set of reduced resolution versions. In some implementations, various other schemes of determination of each of the number of frames ηᵢ may be used, e.g., streaming more frames with higher resolutions than frames with lower resolutions, and so on.

In some implementations, the one or more reduced-resolution versions may be presented without additional processing. In some implementations, the one or more reduced resolution versions may be upsampled using a suitable interpolation upsampling technique, including (but not limited to) nearest-neighbor interpolation, bilinear interpolation, bicubic interpolation, and/or the like. In some implementations, the reduced-resolution version(s) of the media item may be upsampled using one or more deep learning neural network models, e.g., upsampling models 250 in FIG. 2. In some implementations, upsampling models 250 may include deconvolutional neuron networks, e.g., neural networks with multiple neuron layers deploying filters (kernels) with an expanding field of view. In some implementations, upsampling models 250 may include a combination of one or more neuron layers (e.g., convolutional and/or deconvolutional layers) that perform interpolation-based upsampling and one or more neuron layers that further refine the obtained interpolation-based upsampling. In some implementations, upsampling models 250 may include a U-net architecture, in which a convolutional subnetwork downsizes the images (frames) along their height and width dimensions and increases the size of the images along the feature (channel) dimensions. A deconvolutional network then expands the images to the target dimension while simultaneously reducing the number of features down to the target number of channels, e.g., the number of colors. Various additional network architectures can be used, such as networks with residual connections, networks with multiple paths, networks with attention, and/or the like.

One or more upsampling models 250 may be trained using lower-resolution media items as training inputs and higher-resolution media items as the corresponding target outputs (ground truth). In some implementations, training of upsampling models 250 may include generative adversarial training, in which a generative upsampling model is trained together with a discriminative model that is being trained to distinguish between high resolution images and lower-dimension images upsampled to the target resolution. Adversarial (competitive) training of both (generative and discriminative) models teaches the generative models to emulate higher resolution images with more and more accuracy.

Some media items may include data of multiple modalities. For example, videos may include both an image component and an audio component. Different data modalities may be upsampled using different models, e.g., a reduced resolution video component of a media item may be processed by a video upsampling model and a reduced resolution audio component (e.g., soundtrack) of the media item may be processed by an audio upsampling model. The audio upsampling model can be trained to improve the quality of the audio (e.g., from 4-bit audio to 8-bit audio) while maintaining a correct cadence of sounds in the audio, to prevent the soundtrack from desynchronizing from the video.

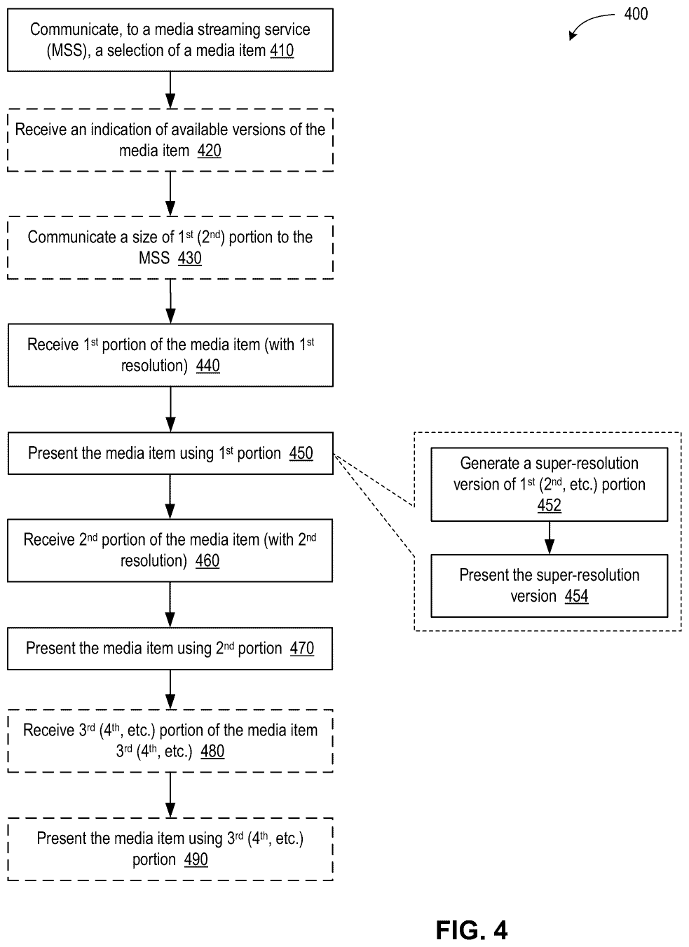

FIG. 4 is a flow diagram of an example method 400 of latency reduction in live streaming of media using one or more reduced-resolution versions of the media items being streamed, in accordance with one or more implementations of the present disclosure. A processing device, having one or more processing units (e.g., CPUs, GPUs, DPUs, and or the like) and memory devices communicatively coupled to the processing units may perform method 400 and/or each of its individual functions, routines, subroutines, or operations. The processing device executing method 400 may be a processing device of user machine 102 (e.g., CPU 114, GPU 116 of FIG. 1 and/or any other suitable processing device not shown in of FIG. 1). In some implementations, any suitable portion of method 400 may be performed by a media streaming service (e.g., media streaming service 120 of FIG. 1). In some implementations, the processing device executing method 400 may perform instructions issued by media application 104, media presentations scheduler 108, media upsampling module 110, resource evaluation module 112, and/or other modules and components of a user device 102, including modules and components installed on the user device by the media streaming service or at the direction of the media streaming service. In certain implementations, a single processing thread may perform method 400. Alternatively, two or more processing threads may perform method 400, each thread executing one or more individual functions, routines, subroutines, or operations of the methods. In an illustrative example, the processing threads implementing method 400 may be synchronized (e.g., using semaphores, critical sections, and/or other thread synchronization mechanisms). Alternatively, the processing threads implementing method 400 may be executed asynchronously with respect to each other. Various operations of method 400 may be performed in a different order compared with the order shown in FIG. 4. Some operations of method 400 may be performed concurrently with other operations. Some operations may be optional.

Method 400 may be implemented to provide efficient and latency-free delivery of media content to users (clients, viewers, listeners, etc.) over network connections. In some implementations, the media streaming service delivering the media content may be performed by a cloud-based media streaming service. At block 410, method 400 may include communicating, to the media streaming service, a selection of a media item from a client device, e.g., user device 102 in FIG. 1. The selection may be made by a user or by media application 104, e.g., automatically, including (but not limited to) selection of an item from a playlist, upon a suggestion from the media service, or in any other suitable way. In some implementations, the media item may include a video, an audio, an animation, an electronic book, and/or any other suitable media content.

At block 420, method 400 may include receiving, from the media streaming service, an indication of a plurality of versions of the media item available to be received by the client device. Individual versions of the plurality of versions of the media item may have a different resolution of a plurality of resolutions, which may include a first resolution, a second resolution, and so on. The number of available resolutions need not be limited.

At block 430, method 400 may include communicating a size of a first portion to be received from the media streaming service, and similarly communicating a size of a second portion, third portion, and so on. The first portion may be the lowest resolution portion to be used for presenting the requested media item to the user, the second portion may be the next lowest resolution portion, and so on. In some implementations, the size of the first portion or the size of the second (third, etc.) portion, and/or any other portions to be received from the media streaming service may be computed based on one or more system metrics associated with the client device. For example, the one or more system metrics may include a current bandwidth of a network connection between the client device and the media streaming service, a current throughput of the network connection between the client device and the media streaming service, a speed of a processing device of the client device, a current utilization of the processing device of the client device, an amount of memory of the client device available to support presentation of the media item on the client device, and/or the like.

At block 440, method 400 may include receiving, from the media streaming service, the first portion of the media item and, at block 450, presenting, using the first portion, the media item on a presentation interface of the client device. In some implementations, presenting the media item may include operations illustrated with the callout portion of FIG. 4. More specifically, at block 452, method 400 may include generating a super-resolution version of the first portion. The term “super-resolution version” should be understood to include any generated version with at least one dimension (in pixels) being higher than the corresponding dimension of the first portion. In some implementations, generating the super-resolution version of the first portion may include processing the first portion using an upsampling neural network model. At block 454, method 400 may continue with presenting the super-resolution version of the first portion on the presentation interface of the client device.

At block 460, method 400 may include receiving, from the media streaming service, the second portion of the media item having the second resolution and, at block 470, presenting the second portion of the media item on the presentation interface of the client device. In some implementations, presenting the second portion may be responsive to an occurrence of a first threshold condition. For example, the first threshold condition may include downloading a target part of the second portion of the media item, e.g., an initial part of the second portion that is sufficient to begin presentation of the second portion while other parts of the second portion are still being downloaded. In some implementations, the threshold condition may include completing the presentation of a predetermined part of the first portion of the media item.

In some implementations, e.g., where the second portion is not a native resolution portion but yet another reduced-resolution portion, operations of block 470 may be performed similarly to operations of block 450. More specifically, such operations may include generating a super-resolution version of the second portion and presenting the super-resolution version of the second portion on the presentation interface of the client device.

At block 480, method 400 may include receiving, from the media streaming service, a third (fourth, etc.) portion of the media item, the third (fourth, etc.) portion having a third (furth, etc.) resolution. The third (fourth, etc.) resolution may be higher than the second (third, etc.) resolution. At block 490, method 400 may include presenting, responsive to an occurrence of a second (third, etc.) threshold condition, the third (fourth, etc.) portion of the media item on the presentation interface of the client device. For example, the second threshold condition may include downloading a target part of the third (fourth, etc.) second portion of the media item, completing presentation of a predetermined part of the second portion of the media item, and/or the like.

In some implementations, a combined duration of the first portion and the second portion (third portion, fourth portion, etc., if more than one reduced resolution portions are being used) may be about the same as the duration of the media item. For example, the second (third, etc.) portion may begin where the first (second, etc.) portion ends. In some implementations, there may be some overlap between the portions, e.g., the second (third, etc.) portion may begin before the first (second, etc.) portion ends. Such scheduling of overlapping portions of the media item may be useful in the instances where network bandwidth/throughput deteriorates unexpectedly and downloading higher-resolution version(s) is delayed. In such instances, presentation of the lower-resolution version(s) may be performed for longer times than originally scheduled. On the other hand, to prevent significant duplication of the downloaded content, the overlap of various portions may be limited. For example, the combined duration of the first portion and the second portion (and any additional portions, if used) may be set to not exceed 105%, 110%, 120%, 125%, etc., of the duration of the media item.

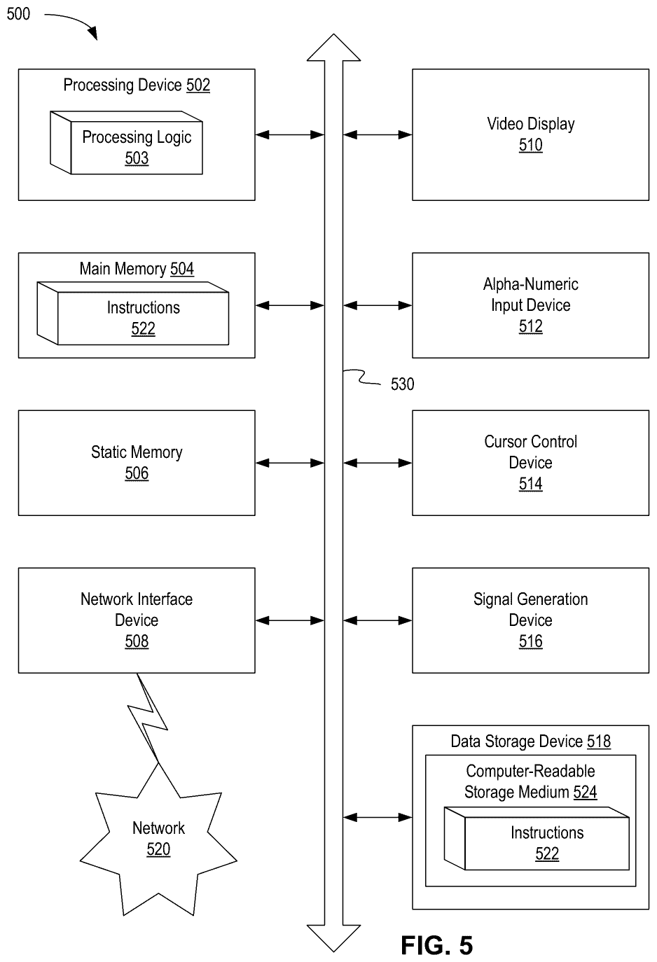

FIG. 5 depicts an example computer system 500 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The example computer system 500 includes a processing device 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 518, which communicate with each other via a bus 530.

Processing device 502 (which can include processing logic 503) represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 522 for implementing method 400 of latency reduction in live streaming of media.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker). In one illustrative example, the video display unit 510, the alphanumeric input device 512, and the cursor control device 514 may be combined into a single component or device (e.g., an LCD touch screen).

The data storage device 518 may include a computer-readable storage medium 524 on which is stored the instructions 522 embodying any one or more of the methodologies or functions described herein. The instructions 522 may also reside, completely or at least partially, within the main memory 504 and/or within the processing device 502 during execution thereof by the computer system 500, the main memory 504 and the processing device 502 also constituting computer-readable media. In some implementations, the instructions 522 may further be transmitted or received over a network 520 via the network interface device 508.

While the computer-readable storage medium 524 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
communicating, to a media streaming service, a selection of a media item from a client device;
receiving, from the media streaming service, a first portion of the media item, the first portion having a first resolution;
presenting, using the first portion, the media item on a presentation interface of the client device;
receiving, from the media streaming service, a second portion of the media item, the second portion having a second resolution; and
presenting, responsive to an occurrence of a first threshold condition, the second portion of the media item on the presentation interface of the client device.

2. The method of claim 1, wherein a combined duration of the first portion and the second portion does not exceed 110% of a duration of the media item.

3. The method of claim 1, wherein presenting, using the first portion, the media item on the presentation interface of the client device comprises:
generating a super-resolution version of the first portion; and
presenting the super-resolution version of the first portion on the presentation interface of the client device.

4. The method of claim 3, wherein generating the super-resolution version of the first portion comprises processing the first portion using an upsampling neural network model.

5. The method of claim 1, wherein the first threshold condition comprises at least one of:
downloading a target part of the second portion of the media item, or
completing presentation of a predetermined part of the first portion of the media item.

6. The method of claim 1, further comprising:
receiving, from the media streaming service, a third portion of the media item, the third portion having a third resolution, wherein the third resolution is higher than the second resolution; and
presenting, responsive to an occurrence of a second threshold condition, the third portion of the media item on the presentation interface of the client device.

7. The method of claim 6, wherein presenting, using the second portion, the media item on the presentation interface of the client device comprises:
generating a super-resolution version of the second portion; and
presenting the super-resolution version of the second portion on the presentation interface of the client device.

8. The method of claim 1, wherein the media item comprises a video.

9. The method of claim 1, further comprising:
receiving, from the media streaming service, an indication of a plurality of versions of the media item available to be received by the client device, each of the plurality of versions of the media item having a respective resolution of a plurality of resolutions, wherein the plurality of resolutions comprises the first resolution and the second resolution, and
communicating a size of the first portion to the media streaming service.

10. The method of claim 1, wherein at least one of a size of the first portion or a size of the second portion is computed based on one or more system metrics associated with the client device.

11. The method of claim 10, wherein the one or more system metrics comprise one or more of:
a current bandwidth of a network connection between the client device and the media streaming service,
a current throughput of the network connection between the client device and the media streaming service,
a speed of a processing device of the client device,
a current utilization of the processing device of the client device, or
an amount of memory of the client device available to support presenting the media item of the presentation interface of the client device.

12. A system comprising:
a memory device, and
a processing device communicatively coupled to the memory device, the processing device to:
communicate, to a media streaming service, a selection of a media item from a client device;
receive, from the media streaming service, a first portion of the media item, the first portion having a first resolution;
present, using the first portion, the media item on a presentation interface of the client device;
receive, from the media streaming service, a second portion of the media item, the second portion having a second resolution; and
present, responsive to an occurrence of a first threshold condition, the second portion of the media item on the presentation interface of the client device.

13. The system of claim 12, wherein to present, using the first portion, the media item on the presentation interface of the client device, the processing device is to:
generate a super-resolution version of the first portion; and
present the super-resolution version of the first portion on the presentation interface of the client device.

14. The system of claim 13, wherein to generate the super-resolution version of the first portion, the processing device is to process the first portion using an upsampling neural network model.

15. The system of claim 12, wherein the first threshold condition comprises at least one of:
downloading a target part of the second portion of the media item, or
completing presentation of a predetermined part of the first portion of the media item.

16. The system of claim 12, wherein the processing device is further to:
receive, from the media streaming service, a third portion of the media item, the third portion having a third resolution, wherein the third resolution is higher than the second resolution; and
presente, responsive to an occurrence of a second threshold condition, the third portion of the media item on the presentation interface of the client device.

17. The system of claim 16, wherein to present, using the second portion, the media item on the presentation interface of the client device, the processing device is to:
generate a super-resolution version of the second portion; and
present the super-resolution version of the second portion on the presentation interface of the client device.

18. The system of claim 12, wherein the processing device is further to:
receive, from the media streaming service, an indication of a plurality of versions of the media item available to be received by the client device, each of the plurality of versions of the media item having a respective resolution of a plurality of resolutions, wherein the plurality of resolutions comprises the first resolution and the second resolution, and
communicate a size of the first portion to the media streaming service.

19. The system of claim 12, wherein at least one of a size of the first portion or a size of the second portion is computed based on one or more system metrics associated with the client device, and wherein the one or more system metrics comprise one or more of:
a current bandwidth of a network connection between the client device and the media streaming service,
a current throughput of the network connection between the client device and the media streaming service,
a speed of a processing device of the client device,
a current utilization of the processing device of the client device, or
an amount of memory of the client device available to support presenting the media item of the presentation interface of the client device.

20. A non-transitory computer-readable storage medium storing instructions that, when executed by a processing device, cause the processing device to:
communicate, to a media streaming service, a selection of a media item from a client device;
receive, from the media streaming service, a first portion of the media item, the first portion having a first resolution;
present, using the first portion, the media item on a presentation interface of the client device;
receive, from the media streaming service, a second portion of the media item, the second portion having a second resolution; and
present, responsive to an occurrence of a first threshold condition, the second portion of the media item on the presentation interface of the client device.
